(19) United States
(12) Patent Application Publication
(10) Pub. No.: US 2012/0059730 A1
(43) Pub. Date: Mar. 8, 2012

(54) INTERACTIVE ELECTRONIC MARKETPLACE

(76) Inventor: Tiffany Jensen, Highland, UT (US)

(21) Appl. No.: 13/225,443

(22) Filed: Sep. 4, 2011

Related U.S. Application Data
(60) Provisional application No. 61/380,704, filed on Sep. 7, 2010.

(51) Int. Cl. G06Q 30/00

(52) U.S. Cl. 705/26.1

(57) ABSTRACT

A promotional marketing method for an electronic marketplace, wherein a user gains exclusive, limited access to the marketplace upon purchase of a membership item. Systems and methods for assigning a virtual prize to a buyer within an electronic marketplace. Systems and methods for creating a product line of collectibles and shipping materials based on a theme established from an image of a graphic.

### RELATED APPLICATIONS

This application claims priority to U.S. Provisional patent application Ser. No. 61/380,704 (Attorney Docket Number: 16611.3) titled “INTERACTIVE ELECTRONIC MARKETPLACE” filed Sep. 7, 2010, which is expressly incorporated herein by reference in its entirety.

### BACKGROUND OF THE INVENTION

1. Field of the Invention

The present invention relates to an interactive electronic marketplace, and more particularly to various promotional marketing methods and strategies for encouraging sales of goods within an electronic marketplace.

2. Background and Related Art

Electronically selling goods or services has become popular. More traditional sales channels include “brick and mortar” storefronts, such as a department store in which a good (e.g., a shirt) can be sold to potential buyers. Other sales channels include catalog sales, door-to-door sales, and telemarketing sales.

With the advent of the electronic market, merchants have been able to sell their products and services to a broader market and customer base. The electronic market has also increased competition among merchants, thereby requiring merchants to lower prices in order to remain competitive within the expanded market. Merchants are further required to offer promotions, such as free shipping, price matching, and deep discounts to maintain their share of the market. With each of these promotions, the profit margin of the merchant is further decreased.

Thus, while techniques currently exist that relate to competing within the electronic market, challenges still exist. Accordingly, it would be an improvement in the art to augment or even replace current techniques with other techniques.

### SUMMARY OF THE INVENTION

The present invention relates to an interactive electronic marketplace, and more particularly to various promotional marketing methods and strategies for encouraging sales of goods within an electronic marketplace.

Implementation of the present invention takes place in association with providing an electronic marketplace. In some implementations, an electronic marketplace is provided as part of a website, wherein buyers may access the website to view and purchase goods and/or services. The electronic marketplace further provides services wherein upon purchasing a good or service, the buyer is awarded or given a virtual prize. In some implementations, the virtual prize corresponds to a feature, function, theme or appearance of the good or service purchased from the electronic marketplace. In other implementations, the virtual prize is used by the buyer to access a feature, function, benefit, credit, character, or other desirable attribute in connection with an electronic game. Examples of electronic games include computer games, online games, social games, applications for hand held devices, electronic games for consoles, video games, electronic games for gaming systems, electronic games for tablets, electronic games for smart televisions, interactive games, or any other electronic game.

In some implementations of the present invention, access to the electronic marketplace is restricted prior to releasing a new product or product line. A buyer may gain access to the electronic marketplace by purchasing an item made available in connection with the electronic marketplace. Upon purchasing the item, the item is either shipped, or electronically transferred to the buyer. The buyer is then granted exclusive access to the electronic marketplace for a period of time, wherein the buyer is given access to the new product or product line prior to releasing the products to the general public.

In some implementations of the present invention, an electronic marketplace is provided or embedded within an interactive gaming environment, wherein users of the interactive gaming environment can access the electronic marketplace. In some implementations, third-party manufacturers are given access to the electronic marketplace, wherein the third-party manufacturers are permitted to sell goods and services which may or may not be directly related to the interactive gaming environment.

Further, in some implementations a product line of collectibles is created based on a theme established from an image of a graphic. The collectibles are then sold in an electronic marketplace in accordance with the teachings of the present invention. In some implementations, the themed-collectibles are sold and then shipped to the buyer in shipping materials that are also created based on the same theme as the themed-collectibles.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a representative system that provides a suitable operating environment for use of embodiments of the present invention;

FIG. 2 illustrates a representative networked system;

FIG. 3 illustrates a schematic representation of a promotional marketing method in accordance with a representative embodiment of the present invention;

FIG. 4 illustrates a schematic representation of a method for assigning a prize in accordance with a representative embodiment of the present invention;

FIG. 5 illustrates a schematic representation of a method for providing a buyer with options of virtual prizes in accordance with a representative embodiment of the present invention;

FIG. 6 illustrates a schematic representation of a method for providing a buyer with a lottery of virtual prizes in accordance with a representative embodiment of the present invention;

FIG. 7 illustrates a schematic representation of a method for providing a buyer with an interchangeable virtual accessory in accordance with a representative embodiment of the present invention;

FIG. 8 illustrates a diagram of an electronic marketplace embedded within an interactive gaming environment in accordance with a representative embodiment of the present invention;

FIG. 9 illustrates a schematic representation of a method for creating a product line of collectibles in accordance with a representative embodiment of the present invention; and

FIG. 10 illustrates a schematic representation of a method for creating a product line of collectibles and theme-based shipping materials in accordance with a representative embodiment of the present invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

The present invention relates to an interactive electronic marketplace, and more particularly to various promotional marketing methods and strategies for encouraging sales of goods within an electronic marketplace.

The following disclosure is grouped into nine subheadings, namely “Representative Operating Environment,” “Promotional Marketing Method for Electronic Marketplace,” Prize for Product Method,” “Interchangeable Virtual Accessory,” “User Selection of Virtual Prize,” “Lottery of Virtual Prizes,” “Electronic Marketplace in Interactive Gaming Environment,” “Product Line of Collectibles Based on Theme from Image of a Graphic,” and “Product Line of Theme-based Collectibles and Shipping Materials.” The utilization of subheadings if for convenience of the reader only and is not construed as limiting in any sense.

### Representative Operating Environment

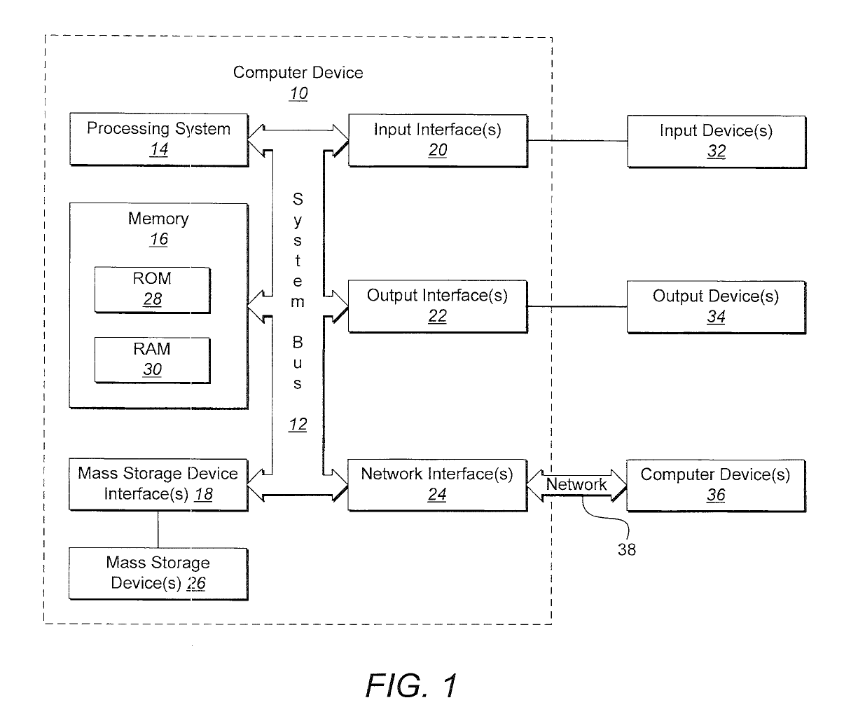

Since at least some embodiments of the present invention embrace utilization of a computer device and/or a networked system, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With continued reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, such as a cellular phone, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10.

Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. Further examples of network interfaces include cellular networks and satellite internet networks. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

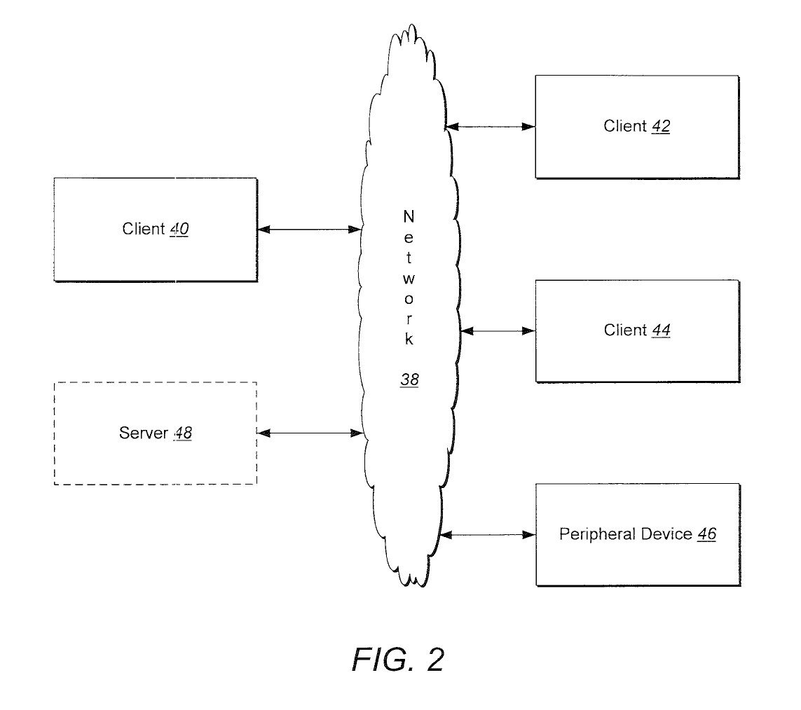

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.) that performs multi-colorant rendering. In another embodiment, the system configuration includes one or more client computer devices, optionally one or more server computer devices, and a connection or network communication that enables the exchange of communication to an output device. Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, cellular networked environments, satellite internet networked environments, and/or wide area networked environments, such as the Internet.

### Promotional Marketing Method for Electronic Marketplace

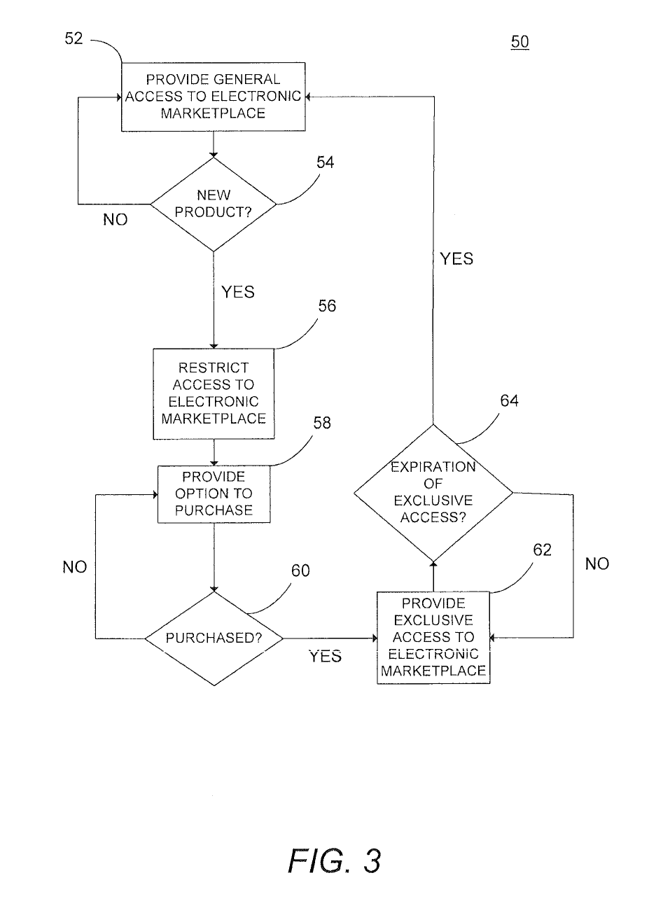

Referring now to FIG. 3, a representative embodiment of a promotional marketing method 50 for an electronic marketplace, is shown. As used herein, the term “electronic marketplace” is used to denote a virtual and/or electronic mercantile establishment or service in which commercial transactions are conducted between a seller and a buyer. For example, in some embodiments an electronic marketplace is a website where a buyer may purchase items or services from a seller, such as a manufacturer or a merchant. In some embodiments, the website is directly accessed via the Internet. In other embodiments, the electronic marketplace is accessed via an application or program installed on an electronic device, such as a personal computer, a laptop computer, a PDA, a tablet computer, a cellular phone, a media player, a gaming consul, and the like. Further, in some embodiments an electronic marketplace comprises a plurality of manufacturers and/or merchants providing a variety of products and services to buyers.

One having skill in the art will appreciate that an electronic marketplace in accordance with some embodiments of the present invention provide a virtual mercantile establishment for the sale of collectible items, non-limiting examples of which may include: plush characters; carvings or figurines made of ceramic, wood, plastic, metal and/or another material; treasure boxes, villages, music boxes, and water globes; collector's blankets; collectible pins; bobble head figures; collectible jewelry; rubber wrist bands; covers and accessories for portable electronic devices; trading cards; slippers and footwear; spa products such as lip gloss or balm, body lotion, bubble bath, body wash, perfume, soaps, candles, sugar and/or salt rubs and accessories; blankets and pillows; pajamas; adult, children and baby clothing; baby items; pet items such as pet bowls, treats, collars, toys and supplies; aprons; eco-bags; pantry or bakery items such as food mixes, honey and wine; kitchen products such as plates, mugs, cups, bowls and utensils; wrapping material; stationary; scrapbook items; purses and handbags; costumes; fabric; books; computer items; birthday items; home decor; paper dolls; and other desirable items.

In some embodiments, the electronic marketplace of marketing method 50 comprises a virtual store or market of a seller hosted on a remote server. In some embodiments, general access to the electronic marketplace is given to the general public 52 whereby the general public may purchase goods and services offered therein. However, prior to releasing a new product, product line, or service 54, access to the electronic marketplace is restricted 56.

In some embodiments, restricted access precludes any buyer from accessing goods and services offered by the seller within the electronic marketplace. In other embodiments, restricted access precludes certain users from accessing goods and services offered within the electronic marketplace, such as users who do not have a membership offered by the seller. Further, in some embodiments restricted access precludes any buyer from accessing certain goods or certain services determined by the seller to be new products 54 or services.

Still further, in some embodiments restricted access 56 precludes any buyer from accessing any portion of the electronic marketplace. For example, in some embodiments a seller restricts access to their electronic marketplace prior to releasing a new product line. Upon attempting to access the electronic marketplace, a buyer is informed of the restricted access status of the marketplace. In some embodiments, the buyer is informed of the restricted access via a written notice or warning that is presented to the buyer upon trying to access the electronic marketplace. In other embodiments, the buyer is apprised of the restricted status via a visual or graphical representation of the marketplace being closed, locked down, or otherwise inaccessible. Such a graphical representation may include a pair of doors closed with a lock. In some embodiments, the buyer is apprised of the restricted status via a combination of written and visual notifications.

While under restricted access status, a buyer may gain exclusive access to the electronic marketplace by purchasing a membership item 58. A membership item may include any physical or virtual good or service. In some embodiments, a membership item comprises a collectible trinket that is shipped to the buyer following purchase of the item. In other embodiments, the membership item comprises a virtual prize that is electronically transferred to the buyer following purchase of the item. Examples of virtual prizes include any type of benefit, feature, image, currency, credit, access, service or other desirable item. Some virtual prizes can be redeemed electronically. Some virtual prizes can be redeemed in a non-electronic manner. Still further, in some embodiments membership item 58 comprises a service, such as free shipping, or a code or instructions (such as a “hint”) to a game.

In some embodiments, a status, membership or level is locked. However, once an item is purchased, a status is obtained, level is met, and/or a membership is obtained, the individual has access to the membership, status or level. In some embodiments, the access is unlimited for the individual. In other embodiments, the access includes pre-established restrictions. In some embodiments, the access can be transferred to or shared with a desired beneficiary.

In some embodiments, membership item 58 comprises a piece of a collectible set or collection. For example, in some embodiments membership items are marked with a number to indicate a position within a collection. In other embodiments, membership items 58 are only available for purchase as a membership item. Further, in some embodiments a limited number or quantity of membership items are provided for purchase. Thus, a buyer is motivated to purchased the membership item for at least one of 1) gaining exclusive access to the electronic marketplace; and 2) purchasing and receiving one of the limited-quantity membership items.

Upon purchasing the item 60, the buyer is provided with exclusive access to the electronic marketplace 62. In some embodiments, the period of exclusive access provides the buyer with access to a new product, product line, or service available within the electronic marketplace, to the exclusion of the general public. In some embodiments, the new product 54 comprises a limited number or quantity of items. In other embodiments, a new product line comprises pieces or items that are only available for sale during the period of exclusive access. Thus, a buyer may be motivated to purchase the membership item 58 so that they can receive exclusive access and increase their chances of purchasing a limited quantity item.

In some embodiments, the period of exclusive access 62 is limited to a defined period of time. Thus, upon expiration of the period of time general access is once again provided to the electronic marketplace 52. General access to the electronic marketplace 52 continues until a new product 54 is ready for release, at which time a period of restricted access 56 is once again implemented.

In some embodiments, the exclusive access period of time is defined as a specific duration of time following the initiation of the restricted access status 56. In other embodiments, the exclusive access period of time is determined based on the sale of a specific item or items available within the electronic marketplace. Further, in some embodiments the exclusive access period of time is defined as a determined period of time prior to the release of a new product. For example, in some embodiments the period of exclusive access terminates at approximately two weeks after a new product, product line, or service is released. In other embodiments, the period of exclusive access terminates when a limited-quantity item is sold-out. Further, in some embodiments the period of exclusive access terminates at approximately three months prior to the release of a new product, product line, or service.

### Prize for Product Method

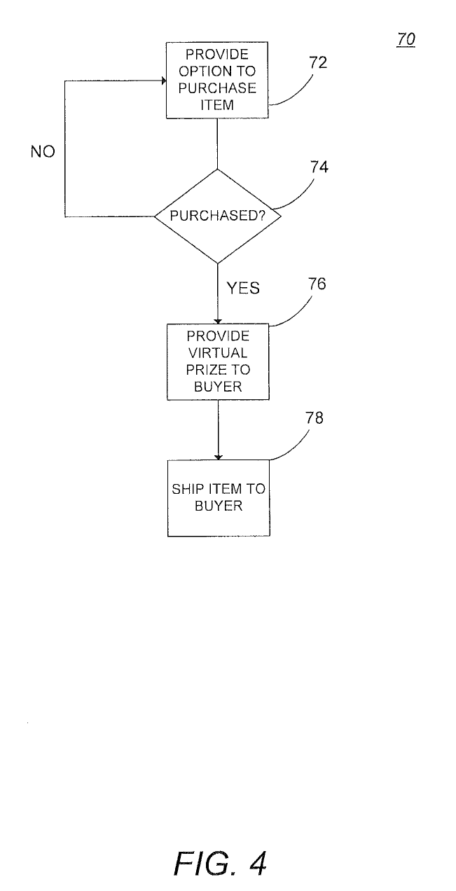

Referring now to FIG. 4, a representative embodiment of a prize for product method 70 is shown. In some embodiments, a buyer visits an electronic marketplace to purchase a desired item. The seller of the desired item may provide incentives to encourage the buyer to make the purchase. For example, in some embodiments the electronic marketplace provides the buyer with an option to purchase a desired item 72. As an incentive to purchase the item, once the item is purchased 74, a virtual prize is awarded or provided to the buyer 76. Further, the desired and purchased item is shipped to the buyer by the seller 78. Those skilled in the art will appreciate that in at least some embodiments the purchased item can be gifted or otherwise transferred by the buyer and thus shipped to the intended recipient. Further in at least some embodiments, the virtual prize can be gifted or otherwise transferred such that it is delivered to an intended recipient.

In some embodiments, the method by which a virtual prize is assigned to a buyer includes a game that the buyer may participate in. For example, in some embodiments an interactive game is provided on, or embedded within the electronic marketplace, wherein upon completion of the game the buyer is provided with a virtual prize. In some embodiments, the interactive game comprises a carnival-theme game. In other embodiments, the interactive game comprises a knowledge-based game. Further, in some embodiments the interactive game comprises an anagram. Still further, in some embodiments the interactive game comprises at least one of a game of chance or a game of skill.

In some embodiments, a virtual prize comprises an electronic file that is electronically transferred to the buyer. For example, in some embodiments the electronic file is transferred to the buyer via email. In other embodiments, the electronic file is transferred to the buyer via direct download from the electronic marketplace. Further, in some embodiments the electronic file is transferred directly to an executable program or hosted application, such as an online game, wherein the electronic file provides a benefit or feature supported by the program and/or application. In some embodiments, the “virtual prize” comprises a tangible gift that is shipped to the buyer either with or without the purchased, desired item.

A buyer may be required to provide a user name and a password to enable accurate linking of the electronic file with a user profile or account which the buyer has created within the program and/or application. Further, in some embodiments the buyer is required to create a user account within an executable program or hosted application prior to receiving the virtual prize. Still further, in some embodiments a buyer is required to create a user account within the electronic marketplace, wherein the user account is linked to an executable program or hosted application which supports the virtual prize. Thus, by logging into the electronic marketplace, the buyer's account is automatically linked to the necessary executable program or hosted application for which the virtual prize is designed.

A virtual prize in accordance with some embodiments of the present invention comprises an electronic file containing an executable code for providing at least one of a feature, a benefit, a power, an ability, a character, an accessory, a weapon, a tool, a permission, an upgrade, a hint, an accessory, a bonus, a currency, a point value, a discount, a preview, a map, a download, an extension, a skin, a promotion, and an access related to an executable program and/or hosted application. In some embodiments, an executable program includes video game software which is loaded onto a video game consul. In some embodiments, a hosted application includes an online video game, such as a social networking game. Thus, in some embodiments a virtual prize is designed to provide a specific benefit to a specific program or application. Thus, a buyer may be motivated to purchase a desired item in order to receive a desired virtual prize.

In some embodiments, a virtual prize is provided which correlates to the desired, purchased item. For example, in some embodiments a buyer purchases a collectible plush animal or other desirable item and is thereafter awarded a virtual prize comprising a two- or three-dimensional avatar of the collectible plush animal or desirable item. In some embodiments, the avatar of the collectible plush animal comprises a model that is used in an electronic game or electronic gaming environment. Examples of electronic games include computer games, online games, social games, applications for hand held devices, electronic games for consoles, video games, electronic games for gaming systems, electronic games for tablets, electronic games for smart televisions, interactive games, or any other electronic game. In other embodiments, the avatar of the collectible plush animal comprises an icon or picture that the buyer uses to represent them within an online and/or electronic game or electronic marketplace.

As used herein, the terms “computer gaming environment” or “electronic gaming environment” are used to denote electronic or digital environments which may or may not include multiple players who either compete or collaborate to accomplish individual and/or shared objectives. In some instances, an electronic and/or computer gaming environment is provided wherein support for collaboration makes certain game activities possible. In other instances, an electronic and/or computer gaming environment is provided comprising a number of virtual communities, wherein users regularly plan ahead to meet within a gaming environment. Still further, in some embodiments an electronic and/or computer gaming environment is provided wherein individual players occupy space within a virtual world, the virtual world being accessible to and occupied by multiple players. Thus, an electronic and/or computer gaming environment in accordance with some embodiments of the present invention suggests a virtual environment within which players may interact to participate in an electronic and/or computer game. In other embodiments, a gaming environment suggests a virtual environment within which players of an electronic and/or computer game may interact outside of actively playing an electronic and/or computer game.

In further example, in some embodiments a buyer purchases a collectible plush animal and is thereafter awarded a virtual prize comprising an accessory that may be used with a digital representation of the collectible plush animal within an electronic and/or computer game. For example, in some embodiments the virtual accessory may include a wand, a sword, a tool, a piece of clothing, an outfit, a bag, a toy, an automobile, a sibling or family member, a pet, an animal, an owner, a cosmetic product, school supplies, farming supplies, money, tokens, credits, and/or food.

Still further, in some embodiments a buyer purchases a collectible plush animal and is thereafter awarded a virtual prize comprises a feature or benefit that may be used with a digital representation of the collectible plush animal within an electronic and/or computer game. For example, in some embodiments the virtual feature or benefit may include a power, an ability, a skill, a hint, a new level, a bonus, an additional life, a code, and/or additional strength. Thus, the buyer is provided with a virtual prize that is desirable as it relates to a use or application within an electronic and/or computer game.

### User Selection of Virtual Prize

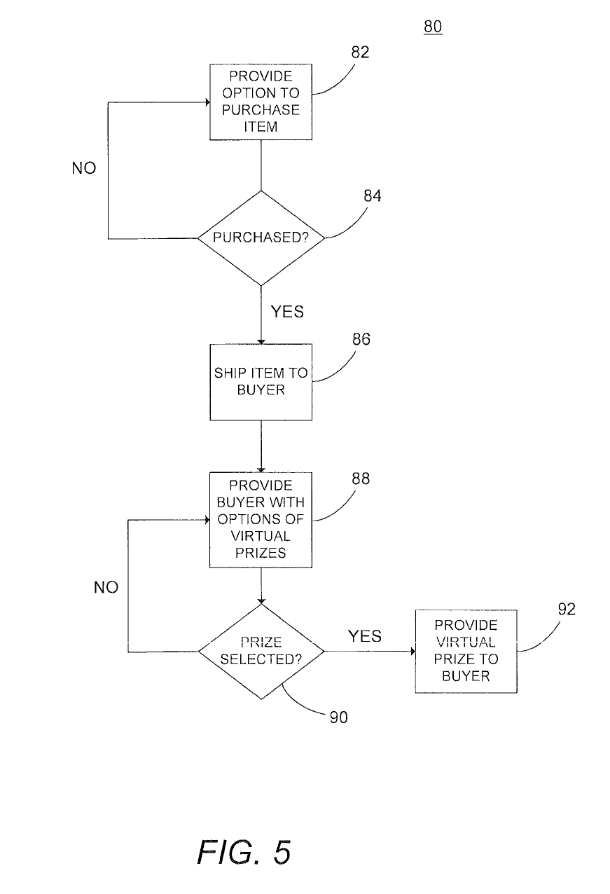

Referring now to FIG. 5, a representative embodiment of a user selection of virtual prize method 80 is shown. In some embodiments, a buyer is first provided with an option to purchase a desired item 82. Upon purchasing the desire item 84, the desired item is shipped to the buyer 86, or to an intended recipient should the buyer desire to gift or otherwise transfer the virtual prize. Further, upon purchasing the desired item, the buyer is provided with options of virtual prizes from which the buyer may select a desired virtual prize 88. Thus, in some embodiments the buyer is not restricted to being automatically assigned a virtual prize, but rather the buyer may select a desired virtual prize from a variety of prizes. Upon selecting a desired virtual prize 90, the virtual prize is transferred to the buyer 92 by at least one of the methods discussed above.

In some embodiments, the virtual prize comprises a collectible electronic trinket that is part of a collectible collection of electronic trinkets or items. Thus, a buyer will desire to collect all of the members or items of the collectible collection. In other embodiments, a virtual prize provides a desired benefit or feature only when combined with other selected virtual prizes. Thus, a buyer will desire to collect all of the required virtual prizes so that they may realize the desired benefit. Therefore, by providing the buyer with options of virtual prizes from which to choose, the seller provides further incentive to the buyer to purchase items from the electronic marketplace. By providing options of virtual prizes, the buyer's confidence in obtaining a desired or needed virtual prize is increased thereby increasing the buyer's motivation to buy.

### Lottery of Virtual Prizes

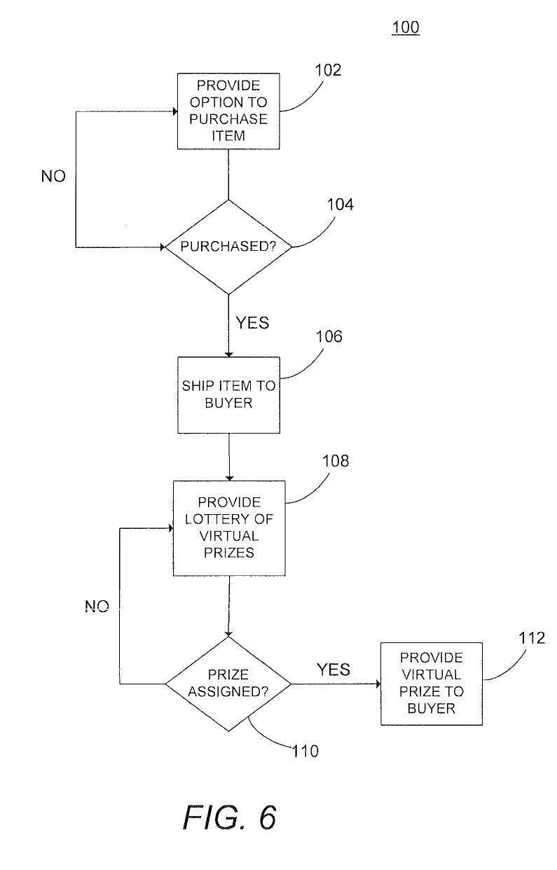

Referring now to FIG. 6, a representative embodiment of a lottery of virtual prizes method 100 is shown. In some embodiments, a buyer is first provided with an option to purchase a desired item 102. Upon purchasing the desired item 104, the desired item is shipped to the buyer 106. Further, upon purchasing the desired item, the buyer is provided with an option to participate in a lottery to receive a virtual prize 108. In some embodiments, the buyer is apprised of the virtual prizes within the lottery. As such, the buyer is aware of the possible virtual prizes that may be acquired through the lottery. In some embodiments, the buyer is apprised of the virtual prizes in the lottery prior to purchasing the desired item. As such, a buyer may select and purchase a desired item based on the chance of receiving a desired virtual prize that is part of the lottery. In other embodiments, the buyer is unaware of which virtual prizes are included in the lottery.

Those skilled in the art will appreciate that embodiments of the present invention embrace other forms, techniques and/or methodologies to reward virtual prizes, including upon purchasing a certain amount of products and/or services, upon obtaining a pre-established amount of credits, tying the virtual prize to a particular item, and other types of distribution techniques and/or methodologies.

### Interchangeable Virtual Accessories

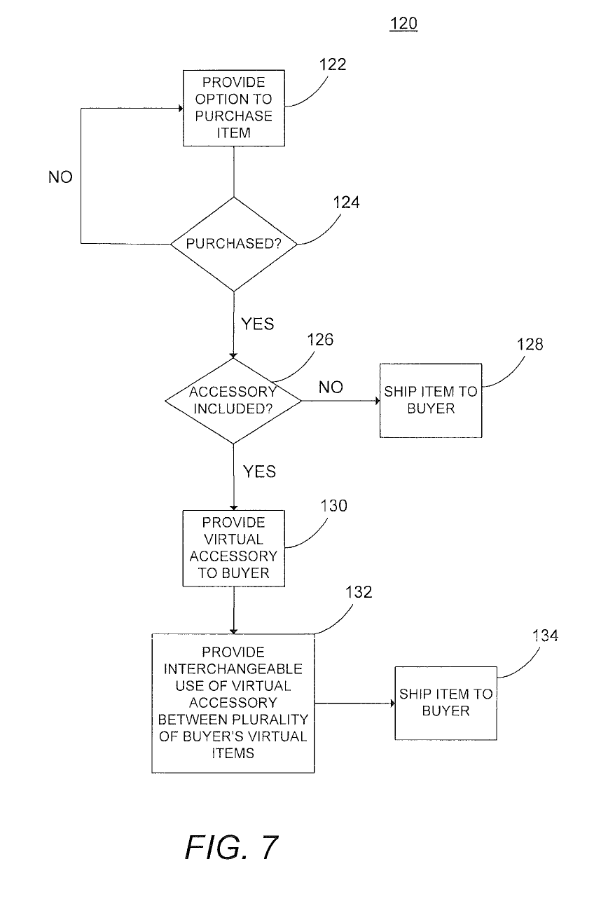

Referring now to FIG. 7, a representative embodiment of an interchangeable virtual accessory method 120 is shown. In some embodiments, a buyer is first provided with an option to purchase a desired item 122. Upon purchasing the desired item 124, a determination is made as to whether the desired item includes an accessory 126. If the desired item does not include an accessory, the purchased desired item is shipped to the buyer 128. However, if the purchased item includes an accessory, in some embodiments a digital representation of the accessory is awarded to the buyer, wherein the digital representation of the accessory may be used within an electronic and/or computer game or a gaming environment. Further, the desired item which includes an accessory is shipped to the buyer 134.

For example, in some embodiments a buyer purchases a collectible plush animal having an accessory, such as a hat or other item, and is thereafter provided with a virtual accessory comprising a digital representation of the purchased accessory (e.g.: a virtual digital hat). In some embodiments, the digital accessory is made available to the buyer in an electronic and/or computer game or computer gaming environment. In some embodiments, the virtual accessory is provided to interact virtually with a digital representation of the collectible plush animal within an electronic and/or computer game. In other embodiments, the virtual accessory is provided to interchangeably interact with plurality of virtual items 132, such as with multiple digitally represented collectible plush animals owned by the buyer, and accessed within an electronic and/or computer game. Thus, a virtual accessory may be interchangeably used by multiple virtual characters, as desired by the buyer. For example, where the virtual accessory is a virtual hat, the virtual hat may be worn by multiple virtual characters within an electronic and/or computer game.

In some embodiments, a virtual prize that is acquired by a buyer may be sold or otherwise transferred to another user within an electronic and/or computer game or computer gaming environment. Thus, in some embodiments a virtual prize, accessory, feature or benefit is a fungible item that may be bought or sold between users of an electronic and/or computer game.

In some embodiments, a virtual prize such as a code, a privilege, an ability, a skill, or another virtual prize originally corresponding to the desired item, is transferred to a purchasing user when the user purchases the physical, desired item from the buyer. Thus, in some embodiments a buyer may purchase or sell both physical and virtual items to other users within an electronic and/or computer game of computer gaming environment. In some embodiments, a buyer may sell a virtual item to a user without transferring the physical, desired item. In other embodiments, a user may sell the physical, desired item to a user without transferring the virtual prize to the user. In some embodiments the electronic marketplace comprises a venue wherein buyers and users may interact and engage in commercial transactions. Further, in other embodiments a venue is provided within an electronic and/or computer game or computer gaming environment wherein buyers and users may interact and engage in commercial transactions involving physical and virtual items relating to the electronic and/or computer game.

### Electronic Marketplace in Interactive Gaming Environment

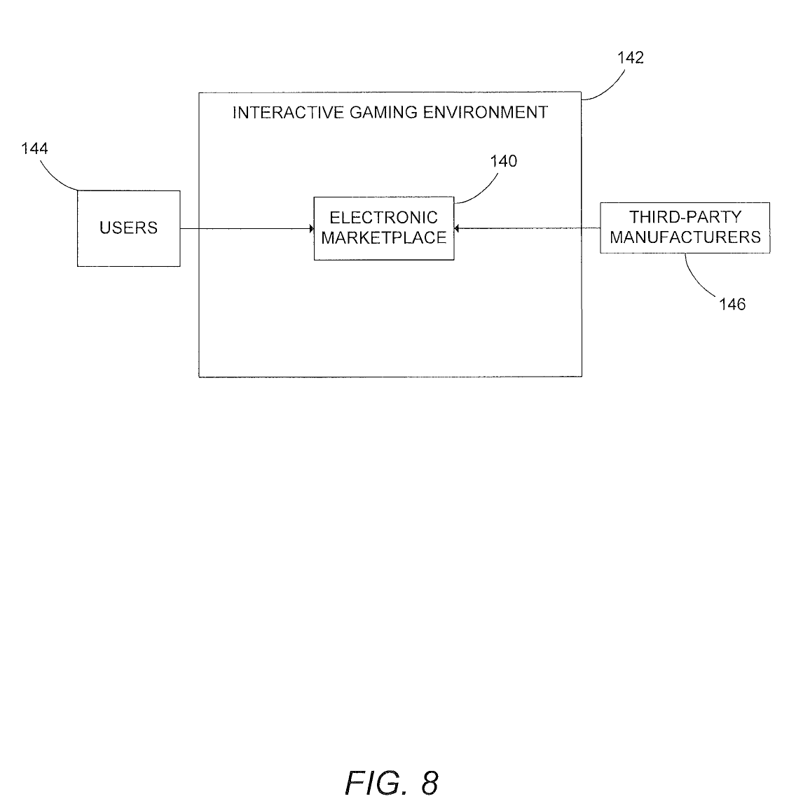

Referring now to FIG. 8, a diagram of an electronic marketplace 40 located within an interactive gaming environment 142, is shown. In some embodiments, an electronic marketplace 140 in accordance with the present invention is provided within an interactive gaming environment 142. As such, users 144 of the interactive gaming environment 142 may directly access electronic marketplace 140 via the gaming environment 142. In some embodiments, electronic marketplace 140 is sponsored by a host server of the interactive gaming environment 142. As such, the host server selects and sells products, goods, and virtual items directly relating to the interactive gaming environment 140. In some embodiments, electronic marketplace 140 is made available to third-party manufacturers 146, wherein the manufacturers 146 are permitted to sell goods and/or services within electronic marketplace 140. In some embodiments, third-party manufacturers 146 sell goods and/or services within the electronic marketplace 140 that are directly related to the interactive gaming environment 142. In other embodiments, third-party manufacturers 146 sell goods and/or services within the electronic marketplace 140 that are unrelated to the interactive gaming environment 142. Further, in some embodiments the third-party manufacturers 146 sell goods and/or services within the electronic marketplace 140 that are both related and unrelated to the interactive gaming environment 142.

### Product Line of Collectibles Based on Theme from Image of a Graphic

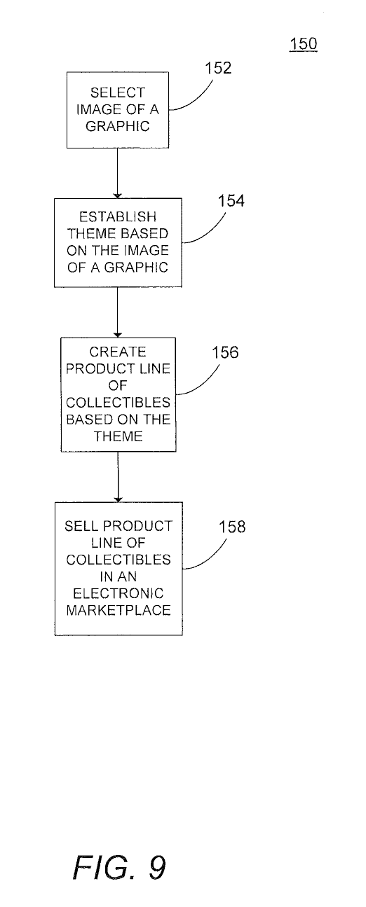

Referring now to FIG. 9, a representative embodiment of a method 150 for providing a product line of collectibles based on a theme derived from an image of a graphic is shown. In some embodiments, a line of collectibles is first created by selecting an image of a graphic 152. As used herein, the term “image of a graphic” is used to denote a graphic that is represented as digital image. Further, as used herein, the term “digital image” is used to denote any image stored as numerical values on optical or magnetic media. In some embodiments, the term “digital image” further denotes any print or reproduction created from such a set of stored numerical values.

Thus, in some embodiments an image of a graphic is first selected 152 and subsequently used to establish a theme based on the image of a graphic 154. For example, in some embodiments an image of a graphic from an electronic and/or computer game is first selected, and then subsequently used to establish a theme for a product line of collectibles. Once a theme has been established, a product line of collectibles is created based on the established theme 156. The product line of collectibles is then sold or provided for sale in an electronic marketplace 158, in accordance with the present invention.

As an example of method 150, in some embodiments a product line, based on a theme established from an image of a graphic from an electronic and/or computer game, is sold in an electronic marketplace embedded within the electronic and/or computer game from which the product line of collectibles is themed. Further, in some embodiments a product line, based on a theme established from an image of a graphic from an electronic and/or computer game, is sold in an electronic marketplace embedded within an interactive gaming environment which is associated with the electronic and/or computer game from which the product line of collectibles is themed. Still further, in some embodiments a product line, based on a theme established from an image of a graphic from an electronic and/or computer game, is sold in an electronic marketplace hosted on a website.

### Product Line of Theme-based Collectibles and Shipping Materials

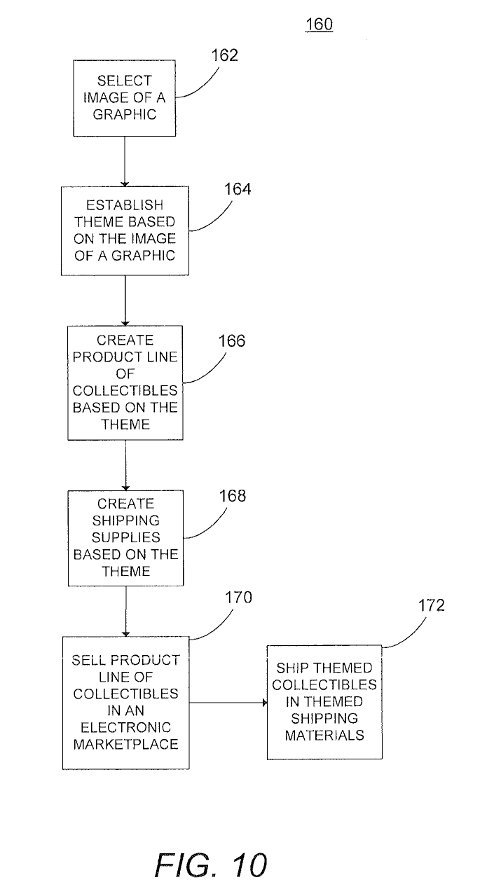

With reference to FIG. 10, a representative embodiment of a method 160 for providing a product line of theme-based collectibles and shipping materials, is shown. In some embodiments, a line of collectibles is first created by selecting an image of a graphic 162. The image of the graphic is subsequently used to establish a theme for a product line of collectibles 164. Using the established theme, a product line of collectibles is then created 166. Again using the established theme, shipping materials are created and provided for shipping the line of collectibles to buyers 168. The product line of collectibles is then sold or provided for sale in an electronic marketplace 170, in accordance with the present invention. When a collectible item has sold, the themed collectible is packaged in the themed shipping materials and shipped to the buyer 172.

As an example of method 160, in some embodiments a product line, based on a theme established from an image of a graphic from an electronic and/or computer game, is sold in an electronic marketplace embedded within the electronic and/or computer game from which the product line of collectibles is themed. Once a collectible item has been sold, the themed collectible item is packaged in shipping materials that were created based on the same theme established and used for the product line of collectibles. Thus, the buyer receives the collectible item in packaging material having a corresponding theme to the collectible item.

In some embodiments, themed shipping material includes a decorative box (e.g., a box made to look like a barn) and decorative packing material (e.g., packing material made to look like hay) to ship a theme collectible (e.g., a plush barn animal, such as a pig). Thus, the established theme is represented in each of the collectible item and shipping materials.

In some embodiments, leveling up takes place in an electronic marketplace. For example, an individual or team can gain points and/or levels by how much that individual or team purchases. Users can compete with others to earn prizes (such as tangible prizes, virtual prized, services for prizes, trips, and/or other desired benefits or items) for higher levels. In some embodiments, leveling up in a market place unlocks exclusive benefits, rewards, leader boards, savings, and/or other benefits.

In at least some embodiments, recognition is given via a social and/or electronic space.

In some embodiments, a virtual punch card is provided such that after an individual purchases a pre-established number of items (i.e. 10, 20 or another number), the individual receives a virtual prize, a free item, a discount, recognition, or another benefit.

In at least some embodiments, a virtual prize can be shared among individuals.

In some embodiments, a virtual prize, purchase, donation, leveling up, punch card, benefit or item can be shared via a social space.

In some embodiments, a manner in which an individual can access a virtual prize that is attached to the purchase of a tangible item or service is by using a user name and/or a password as a way to get the individual's virtual prize. Thus, by way of example, a purchaser can go to a local store (such as a hardware store) and purchase a product or service (such as a screwdriver or other product). After purchasing the product or service, the purchaser can go to an electronic site, such as an electronic marketplace, enter in a username and/or password and receive a virtual reward for the purchase made. In some embodiments, the store provides the username, password and/or electronic identification that is entered into the site to enable the purchaser to obtain the virtual prize. In some embodiments, after the purchase is made, the user enters an electronic marketplace or site and identifies that the purchase of the product was made and thereby receives a virtual prize for having made the purchase at the store.

Embodiments of the present invention relate to an interactive electronic marketplace, and more particularly to various promotional marketing methods and strategies for encouraging sales of goods within an electronic marketplace.

Embodiments of the present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A non-transitory computer readable medium product comprising computer readable instruction for implementing a method of promoting a new product within an electronic marketplace, the computer readable medium product comprising executable code for implementing the steps for:
providing general access to an electronic marketplace;
determining the presence of a new product;
restricting access to the electronic marketplace;
providing an option to purchase a membership item;
determining a purchase of the membership item;
providing a period of exclusive access to the electronic marketplace in response to the purchase of the membership item;
determining an expiration of the period of exclusive access to the electronic marketplace; and
providing general access to the electronic marketplace in response to the expiration of the period of exclusive access to the electronic marketplace.

2. A method for promoting a new product within an electronic marketplace, the method comprising:
providing general access to an electronic marketplace;
determining the presence of a new product;
restricting access to the electronic marketplace;
providing an option to purchase a membership item;
determining a purchase of the membership item;
providing a period of exclusive access to the electronic marketplace in response to the purchase of the membership item;
determining an expiration of the period of exclusive access to the electronic marketplace; and
providing general access to the electronic marketplace in response to the expiration of the period of exclusive access to the electronic marketplace.
